(19) United States
(12) Patent Application Publication
(10) Pub. No.: US 2003/0211834 A1
(43) Pub. Date: Nov. 13, 2003

(54) Mobile phone

(76) Inventors: Kuo-Hsiang Wu, Taipei (TW); Hsiang-Lung Kao, Taipei (TW); Yung-Fa Cheng, Taipei (TW)

Correspondence Address: RABIN & CHAMPAGNE, PC, 1101 14TH STREET, NW, SUITE 500, WASHINGTON, DC, 20005, US

(21) Appl. No.: 10/317,101

(22) Filed: Dec. 12, 2002

(30) Foreign Application Priority Data
May 13, 2002 (TW) 091206776

(51) Int. Cl. H04M 1/00

(52) U.S. Cl. 455/90.3; 455/550.1

(57) ABSTRACT

The Invention describes a design of mobile phone. The design includes a phone body, a keypad module, and a covering lid. The phone body has a surface port to which the keypad module can be attached. The attachment of the keypad module secures the battery inside the phone body firmly, and thus reinforces the structural strength of the mobile phone. Different keypad modules can be attached, and thus increases the variety the phone can offer. The keypad module is connected to the main circuit board electrically through the keypad connector. The covering lid, pivoted by the cover hinge, can be rotationally moved relatively to the phone body.

This application incorporates by reference Taiwan application Serial No. 091206776, filed May, 13, 2002

### BACKGROUND OF THE INVENTION

1. Field of the Invention

The invention relates in general to a mobile phone, and more particularly to a mobile phone with detachable keypad, and strengthened phone structure.

2. Description of the Related Art

The widespread use of portable electronic devices, e.g. mobile phone, has already become everyday necessities for most of the population. The functionalities of most of the mobile phones from different manufactures differ only slightly. Therefore, the questions of how to strengthen the external structure of the mobile phone, and of how to add in more differential features, have become a focused pursue of strategic advantage for most of the manufactures.

FIG. 1 displays a conventional design of a mobile phone 100. It has a phone body 110, a keypad module 120, and a covering lid 130. Generally speaking, the keypad 120 is fixed on top of the phone body 110, and both the keypad 120 and the phone body 110 are electrically connected to the internal circuit board 140. Even though, the battery lid 150 can be used to mount and un-mount the battery 160 easily, the external structure of the mobile phone 100 is thereby weakened. When impacted by sudden and large external forces, e.g. fallen to the ground, the battery lid 150 will drop off from the phone body 110. This will dismantle the battery 160 from the phone body 110, and probably causes damage to others components on the phone body 110 or the battery 160 itself. Additionally, the keypad 120 is permanently fixed on the phone body 110 in the conventional mobile phone 100, which could rarely satisfy the demand of innovation and fashion of modern consumers.

It can be summarized from the foregoing disclosure that the conventional mobile phone has the following drawbacks:

1. Relatively weaker external structure: The design of the battery lid is mainly for the convenience of mounting and un-mounting of the battery, but it also causes those problems such as that the components of the phone body can consequently be damaged when the phone body is torn apart due to its weaker external structure in the case of falling to the ground.

2. Limited diversity of the outlook: The fixed keypad module on the phone body undermines the overall competitiveness of the mobile phone due to it limited design features.

### SUMMARY OF THE INVENTION

The Invention aims at providing a mobile phone that:

1. has reinforced structure strength, and

2. has detachable and changeable keypad.

The mobile phone of this invention includes a phone body, a keypad module and a covering lid. The phone body has a surface port, underneath which is the main circuit board. A keypad connector is extended from the main circuit and provides electrical connection for the keypad module to the main circuit. The covering lid is connected to the phone body through the covering lid hinge, and can rotate relatively to the phone body. The keypad module can be attached to the surface port, and thereby secures the battery inside the phone body.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) depicts an example of a conventional mobile phone.

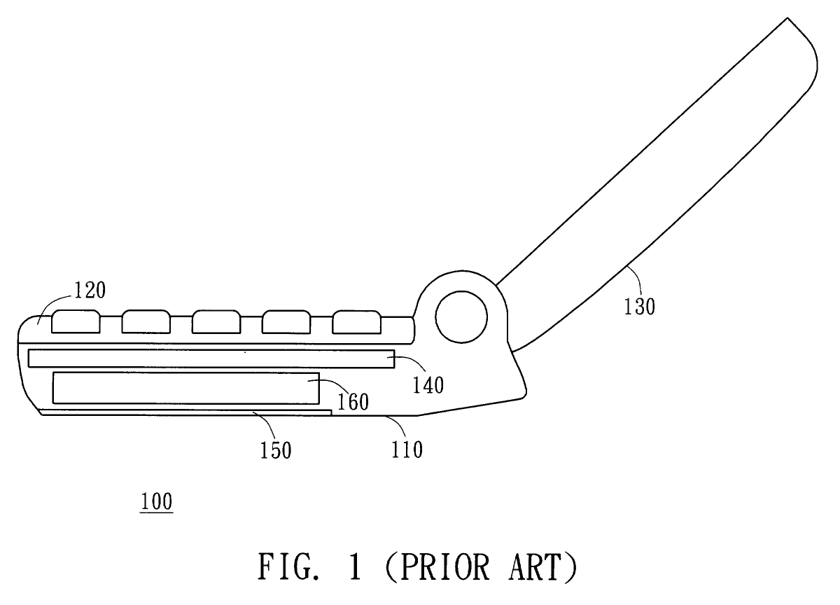

FIG. 2 depicts the structure of a mobile phone according to a preferred embodiment of the invention.

FIG. 3 shows the detachable keypad module according to a preferred embodiment of the invention.

### DETAILED DESCRIPTION OF THE INVENTION

The focus of the Invention is the detachable keypad module. The Invention discards the traditional method of mounting/un-mounting the battery through the battery lid and promotes the new idea of the surface port. The surface port can be used to attach the keypad module on top of the phone body, and the attached keypad module plays the role of securing the battery inside the phone body. The keypad module can be replaced by customers' demands, and hence increases the variety of the features a mobile phone can has. The Invention describes the new structure of the mobile phone with improved structural strength and increased value in terms of its changeable features.

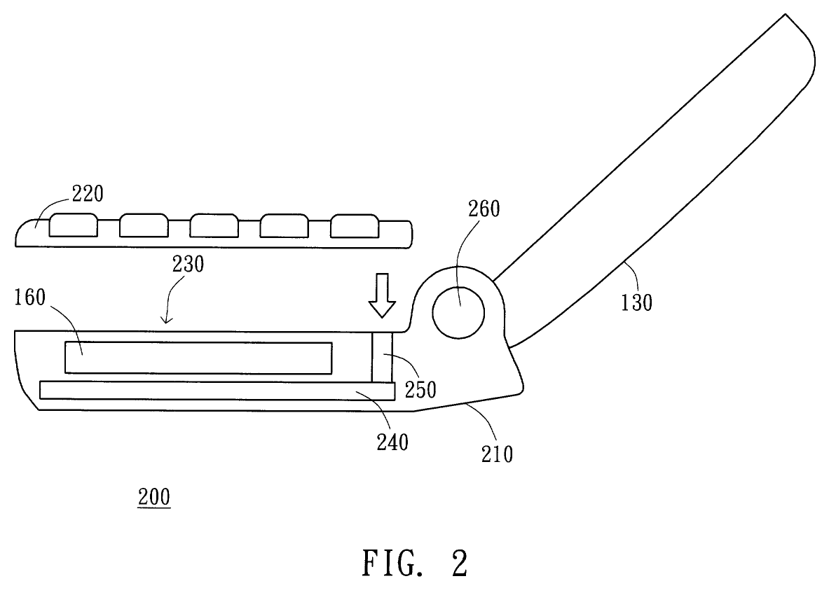

FIG. 2 depicts an example of the Invention's mobile phone structure. The mobile phone 200 has a phone body 210, a keypad module 220, and a covering lid 130. The phone body has relatively stronger structural strength than the conventional mobile phones because of the replacement of the battery lid by its new structure. The phone body 210 has the surface port 230, and internally contains the battery 160 and the main circuit board 240. The keypad module 220 can be attached directly on the surface port 230, preferably by clasping, and connected to the main circuit 240 electrically through the keypad connector 250. By attaching the keypad module 220 to the surface port 230, the battery 160 can be secured firmly inside the battery body 210. The covering lid 130 is connected by the covering lid hinge 260 to the phone body 210, and can therefore rotate relatively to the phone body in order to cover, and uncover the top of the mobile phone 200.

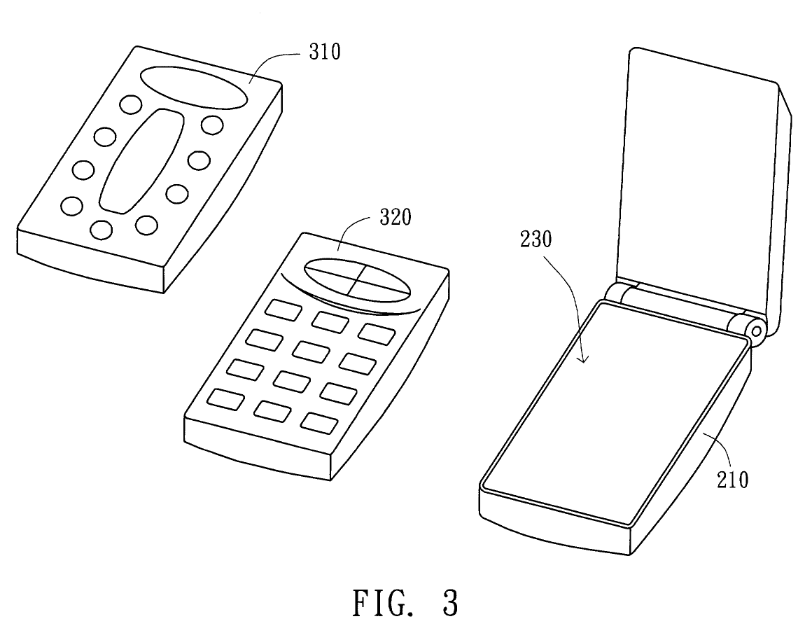

In addition to the stronger structural strength, the Invention also caters for the need of variety and fashion of modern consumers. FIG. 3 demonstrates the idea of detachable keypad module. The keypad module can be attached to the surface port 230 of the phone body 210. Therefore, either keypad module 310 or keypad module 320 can be attached to the same phone body 210.

Please be noted that the geometric structures shown in the figures are just examples of the Invention. Those figures do not set the limit on how can the Invention can be applied and embodied. Any modifications following the same ideas of the Invention are still in the scope of the Invention.

Hence, the mobile phone fabricated according to the invention has at least the following advantages: reinforced structure strength, and detachable and replaceable keypad.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mobile phone, comprising:
a phone body comprising a surface port and an internal circuit board, wherein the internal circuit board comprises an extended keypad connector; and
a keypad module, which can be removably attached to the surface port, and gets connected to the internal circuit board electrically through the keypad connector.

2. The mobile phone according to claim 1, wherein the keypad module is clasped at the surface port of the phone body.

3. The mobile phone according to claim 1, wherein a battery is installed internally in the phone body and the keypad module secures the battery firmly inside the mobile phone.

4. A mobile phone, comprising:
a phone body comprising a surface port and an internal circuit board, wherein the internal circuit board comprises an extended keypad connector;
a keypad module, which can be removably attached to the surface port, and gets connected to the internal circuit board electrically through the keypad connector; and
a covering lid, which is connected to the phone body by a hinge so that the covering lid can rotate relative to the phone body.

5. The mobile phone according to claim 4, wherein the keypad module is clasped at the surface port of the phone body.

6. The mobile phone according to claim 4, wherein a battery is installed internally in the phone body and the keypad module secures the battery firmly inside the mobile phone.

7. The mobile phone according to claim 6, wherein the keypad module is clasped at the surface port of the phone body.
